(19) United States
(12) Patent Application Publication
(10) Pub. No.: US 2002/0017048 A1
(43) Pub. Date: Feb. 14, 2002

(54) Combination fisherman's pliers

(76) Inventor: Soloman Lam, Wellington, FL (US)

Correspondence Address: Mark D. Bowen, Stears Weaver Miller, et al., Suite 1900, 200 East Broward Boulevard, Fort Lauderdale, FL, 33301, US

(21) Appl. No.: 09/875,478

(22) Filed: Jun. 6, 2001

Related U.S. Application Data
(60) Provisional application No. 60/209,740, filed on Jun. 6, 2000.

(51) Int. Cl. A01K 1/00

(52) U.S. Cl. 43/4

(57) ABSTRACT

Fisherman's pliers having pivotally connected members, each member having a handle portion and a jaw portion. A first handle incorporates a weight measuring apparatus partially housed within a longitudinal axial bore defined therein. The weight measuring apparatus preferably includes an elongate rigid plunger having weight indicating indicia thereon, a compressible spring, and a clasp. Attachment of a mass, such as a fish, causes compression of spring such that the weight of the fish is indicated. In an electronic embodiment, the weight measuring apparatus may further include electronic means for digitally displaying the recorded weight. A second handle includes a length measuring apparatus housed within a longitudinal axial bore defined therein. In a preferred embodiment, the length measuring apparatus comprises a telescopically extendable and retractable length-measuring device having length-indicating indicia thereon. In an electronic embodiment, the weight measuring apparatus may further include electronic means for digitally displaying the measured length. Furthermore, an electronic embodiment preferably includes electronic data storage means for storing data, such as length, weight, time, day, catch number and/or location.

### CROSS REFERENCE TO RELATED APPLICATIONS

This application claims the benefit of U.S. provisional patent application Serial No. 60/209,740, filed Jun. 6, 2000.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all rights whatsoever.

### BACKGROUND OF THE INVENTION

1. Field of the Invention

The present invention relates generally to hand tools, and more particularly to fishermens' pliers having a handle configuration adapted to respectively incorporate weight and length measuring devices.

2. Description of the Background Art

The sport of fishing is a popular sport enjoyed by many. There are a number of fishing tools known in the art for use in connection with fishing. One tool commonly employed by fisherman is a pair of pliers. Pliers are useful in rigging and maintaining fishing rods, removing hooks, repair and replacement of various components, and other useful purposes. Every well-equipped fisherman has a pair of pliers. In addition, fishermen often employ measuring devices for use in determining the weight and length of any given catch. Weight and length are particularly important physical characteristics that may determine whether a particular catch must be released.

The background art reveals a number devices intended for use in connection with the sport of fishing. For example, U.S. Pat. No. 2,003,893, issued to La Pan (1934), discloses a fishing rod having a handgrip that accommodates a measuring tape and a spring weight scale. U.S. Pat. No. 2,549,462, issued to Haman (1946), discloses a fisherman's pliers having handles that incorporate a fibrous material, suitable for cleaning fish hooks, and a knife blade. U.S. Pat. No. 3,808,915, issued to Bonnel (1974), discloses a spring clamp hand tool, for use while in fishing, which has a handle incorporating a length measuring scale. U.S. Pat. No. 4,631,851, issued to Whitehurst (1986), discloses a fishing net incorporating a weight scale and a length scale. U.S. Pat. No. 4,787,109, issued to Bennet (1988), discloses a multiple use hand tool for use in fishing. The device includes a serrated edge for use a scraper and for removing fishing hooks. U.S. Pat. No. 5,207,012, issued to Lael (1993), discloses a pair of cross jaw pliers having a container in each handle. One container is used to store and dispense fishhooks, and the other for split shot sinkers. U.S. Pat. No. 5,568,698, issued to Harding et al. (1996), discloses a multipurpose fishing tool having a pair of bent long nose pliers having handles that include a tape measure and a flashlight. U.S. Pat. No. 5,850,649, issued to Simpson (1998), discloses a fishing tool having a handle portion incorporating a whetstone (34) for sharpening the points of “jigs”.

The background art, however, fails to disclose a fisherman's hand tool that incorporates length and weight measuring capabilities.

### BRIEF SUMMARY OF THE INVENTION

Based on the foregoing, it is a primary object of the instant invention to provide pliers adapted for use in the sport of fishing.

It is also an object of the present invention to provide a pair of pliers adapted with integral weight and length measuring devices.

Still another object of the present invention is to provide combination pliers having a handle portion adapted to incorporate a telescopically deployable length measuring scale.

Yet another object of the present invention is to provide combination pliers having a handle portion adapted to incorporate a weight measuring scale.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is a side view of the preferred embodiment of the pliers of the instant invention in partial cross-section;

FIG. 2 is a partial side cross-sectional view of the handle portion of the pliers shown in FIG. 1;

FIG. 3 is a side view of an alternate electronic embodiment of the present invention;

FIG. 4 is a partial side view of the electronic embodiment illustrating length measurement; and

FIG. 5 is a partial side view of the electronic embodiment illustrating weight measurement.

### DETAILED DESCRIPTION OF THE INVENTION

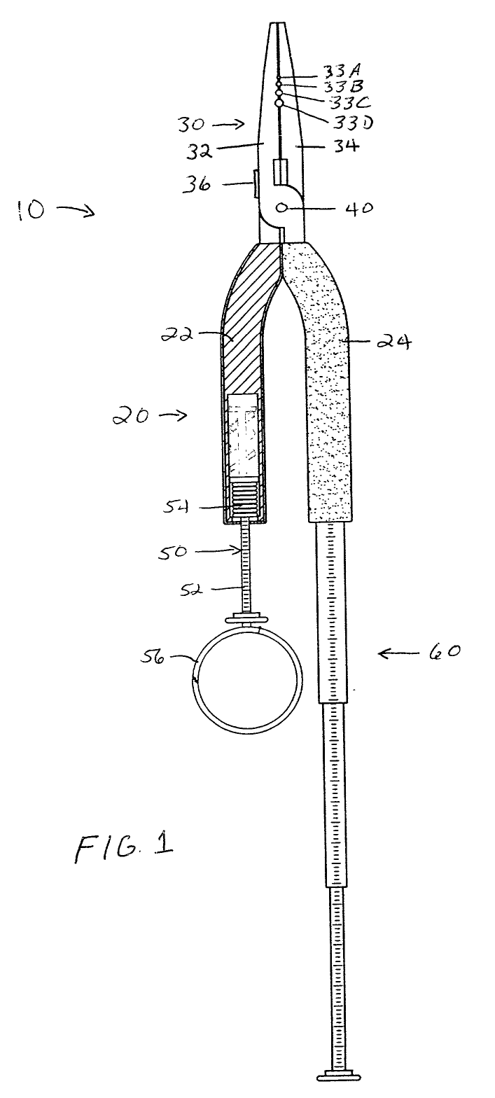

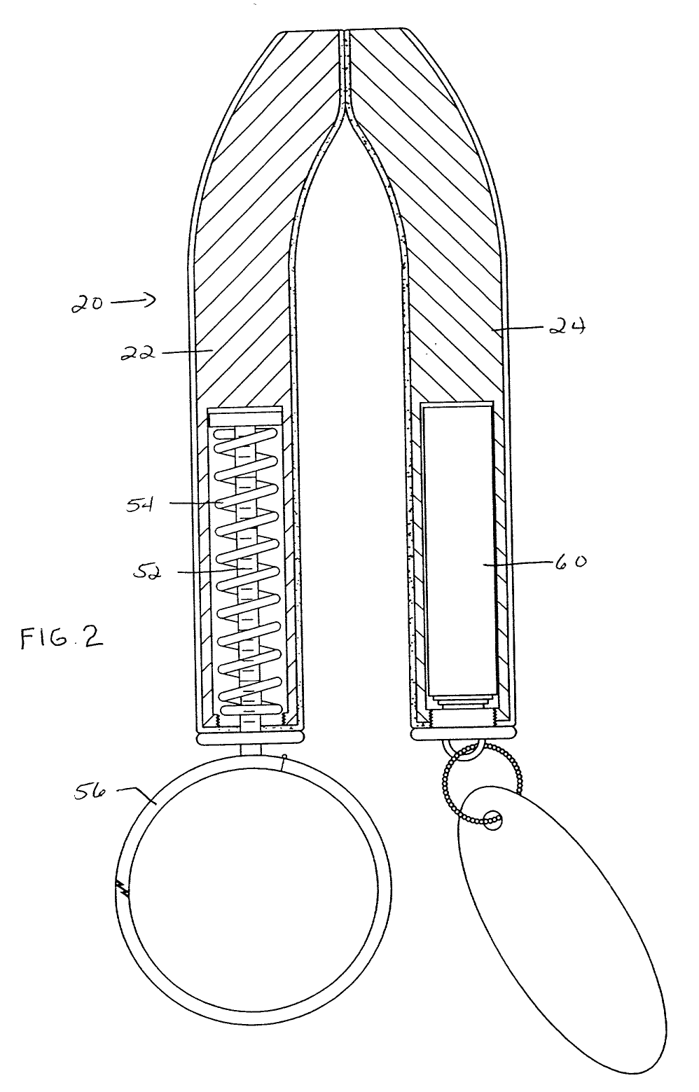

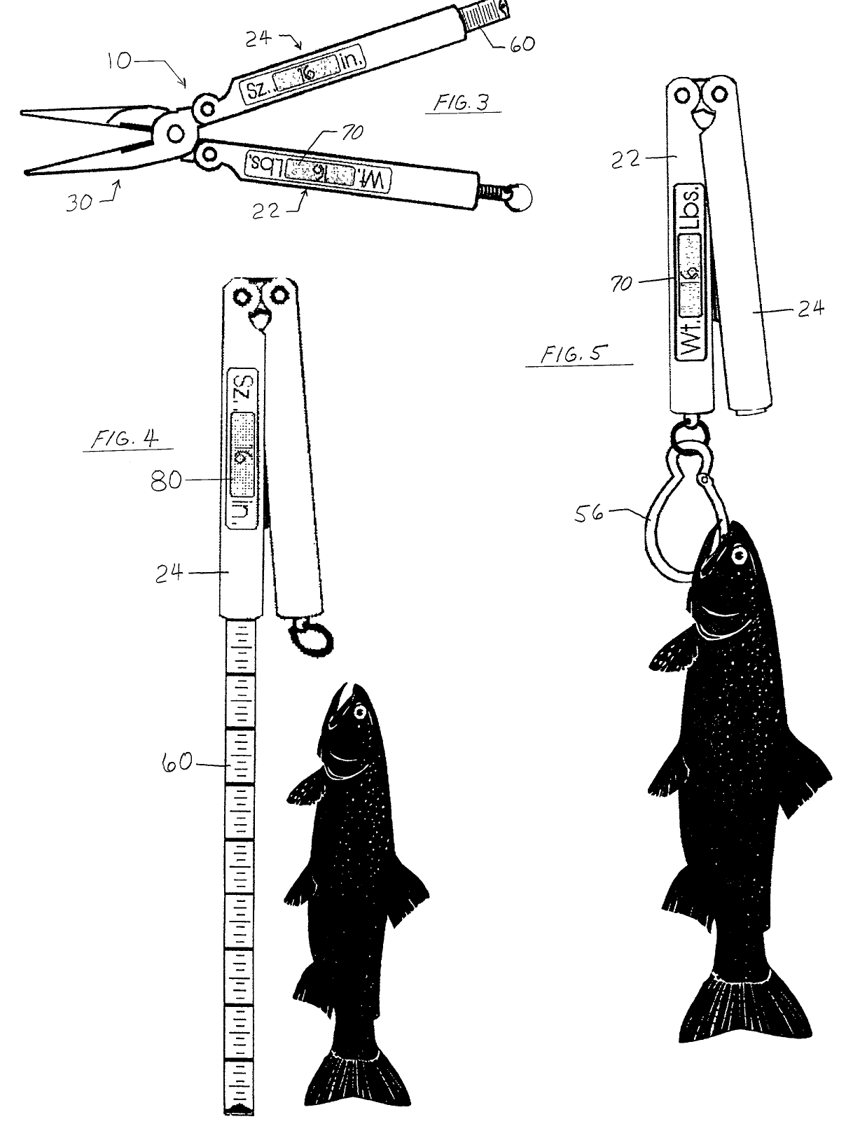

With reference to the drawings, FIGS. 1 and 2 depict a preferred embodiment of the instant invention, namely fisherman's pliers generally identified by the reference numeral 10. Referring to FIG. 1, instant invention 10 comprises a pair of cross jaw pliers having a handle portion, generally referenced as 20, with individual handles 22 and 24. Pliers 10 further included a jaw portion, generally referenced as 30, with jaw elements 32 and 34, pivotally connected by a pivot pin 40. Pliers 10 may be fabricated from tool grade steel, ceramic material, hardened plastic or any other suitable material. Handles 22 and 24 may further include mid-handle hinges (not shown) for allowing the handles to be folded into a compact configuration for carrying and/or storage in tackle boxes where storage space is at a premium. Jaw portion 30 preferably includes a plurality of variously sized apertures, referenced as 33 A-D, for use in crimping various components to fishing lines and/or leader rigs. In addition, the device preferably includes a sharpening surface 36 adapted for use in the sharpening of fishing hooks.

Handle 22 includes a weight measuring apparatus, generally referenced as 50, partially housed within a longitudinal axial bore defined within handle 22 and thus incorporated therein. Weight measuring apparatus 50 preferably includes an elongate rigid plunger 52 having weight indicating indicia thereon, a compressible spring 54 and a clasp 56. FIG. 2 depicts the weight measuring apparatus in a normally retracted position. As best seen in FIG. 1, the attachment of a mass, such as a fish, to clasp 56 causes compression of spring 54 such that the weight of the mass is indicated by the indicia on plunger 52. As best seen in FIGS. 3 and 5, weight measuring apparatus 50 may further include electronic LCD display 70 for digitally displaying the weight of a fish. The means for digitally displaying weight preferably includes power source means (battery, solar, etc.), electronic circuitry and a display, LCD, graphical, and/or digital. The device may further include means for storing data (weight, time, day, catch number and/or location) such as a RAM memory chip or other electronic data storage means.

Handle 24 includes a length measuring apparatus, generally referenced as 60, housed within a longitudinal axial bore defined by handle 24 and thus incorporated therein. In a preferred embodiment, length-measuring apparatus 60 comprises a telescopically extendable and retractable length-measuring device having length-indicating indicia thereon. The length indicating indicia may be in English units (e.g. inches) or Metric units (e.g. centimeters) or both. Length measuring apparatus 60 may be fabricated from any suitable material and may preferably be fabricated from a flexible plastic type material for durability and resistance to breakage and/or fracture. Length measuring apparatus 60 may further include an electronic LCD display 80 for digitally displaying the length of the fish. The means for digitally displaying length preferably includes power source means (battery, solar, etc.), electronic circuitry and a display (LCD, graphical, and/or digital). The device may further include means for storing data (length, weight, time, day, catch number and/or location) such as a RAM memory chip or other electronic data storage means.

The instant invention has been shown and described herein in what is considered to be the most practical and preferred embodiment. It is recognized, however, that departures may be made therefrom within the scope of the invention and that obvious structural and/or functional modifications will occur to a person skilled in the art.

What I claim is:

1, A fisherman's hand tool comprising:
a first elongate pivoting member having a forward end and a rearward end, said forward end forming a first jaw and said rearward end forming a first handle;
a second elongate pivoting member having a forward end and a rearward end, said forward end forming a second jaw and said rearward end forming a second handle;
said first and second pivoting members each being pivotally connected between said forward ends and said rearward ends;
said first handle incorporating a deployable length measuring apparatus;
said second handle incorporating a weight measuring apparatus.

2. A fisherman's hand tool according to claim 1, further including a sharpening surface disposed on said one of said first or second members.

3. A fisherman's hand tool according to claim 1, wherein said deployable length measuring apparatus comprises elongate flexible member said elongate flexible member being manually adjustable from a stored configuration wherein said flexible member is substantially housed within said first handle to a deployed configuration wherein said flexible member is extended from the rearward end of said first handle, said flexible member having length measuring indicia thereon.

4. A fisherman's hand tool according to claim 3, wherein said length measuring apparatus further includes electronic means for displaying length information, said electronic means responsive to extension of said flexible member so as to generate an electronic display corresponding to the extended length of said flexible member.

5. A fisherman's hand tool according to claim 4, further including electronic data storage means for selectively storing data corresponding to length measurements generated by said length measuring device.

6. A fisherman's hand tool according to claim 1, wherein said weight measuring apparatus includes electronic means for displaying weight information, said electronic means responsive to weight sensed by said weight measuring apparatus so as to generate an electronic display corresponding to the weight sensed by said weight measuring apparatus.

7. A fisherman's hand tool according to claim 6, further including electronic data storage means for selectively storing data corresponding to weight measurements generated by said weight measuring apparatus.

8. A fisherman's hand tool comprising:
a first elongate pivoting member having a forward end and a rearward end, said forward end forming a first jaw and said rearward end forming a first handle;
a second elongate pivoting member having a forward end and a rearward end, said forward end forming a second jaw and said rearward end forming a second handle;
said first and second pivoting members each being pivotally connected between said forward ends and said rearward ends;
said first handle incorporating a deployable length measuring apparatus, said length measuring apparatus including a deployable measuring member capable of being manually extended from said first handle, said measuring apparatus further including electronic means for displaying length information, said electronic means for displaying being responsive to extension of said measuring member so as to generate an electronic display corresponding to the extended length of said measuring member;
said second handle incorporating a weight measuring apparatus including electronic means for displaying weight information, said electronic means responsive to weight sensed by said weight measuring apparatus so as to generate an electronic display corresponding to the weight sensed by said weight measuring apparatus.
